(19) United States
(12) Patent Application Publication
(10) Pub. No.: US 2002/0185774 A1
(43) Pub. Date: Dec. 12, 2002

(54) Film-stretching system

(75) Inventor: Bruno Haider, Gmunden (AT)

Correspondence Address: STEPTOE & JOHNSON LLP, 1330 Connecticut Ave., NW, Washington, DC, 20036, US

(73) Assignee: SML MASCHINENGESELLSCHAFT M.B.H., Lenzing (AT)

(21) Appl. No.: 10/162,209

(22) Filed: Jun. 5, 2002

(30) Foreign Application Priority Data
Jun. 6, 2001 (AT) A 878/2001

(51) Int. Cl. B29C 67/20; D06C 3/00

(52) U.S. Cl. 264/154; 264/288.8; 26/71

(57) ABSTRACT

Apparatus (1) for monoaxial stretching of a synthetic film (2) under tension using a roller arrangement in which there are at least two stretching rollers (3) defining a stretching gap (4), where, in order to produce a breathable synthetic film (2) by means of tensile strain, the stretching rollers (3) for the cold-stretching of the synthetic film (2) have surfaces which increase the coefficient of friction.

The invention relates to an apparatus for monoaxial stretching of a synthetic film under tension using a roller arrangement which has at least two stretching rollers which define a stretching gap, and also to a process for monoaxial stretching of a synthetic film under tension, in which the synthetic film is passed through at least one stretching gap defined by two stretching rollers.

Films are typically stretched monoaxially in the machine direction, in order to improve their mechanical and optical properties. This type of stretching is in particular aimed at producing a film with high strength in the direction of stretching and with a particularly glossy surface. This involves what is known as hot stretching, in which the film is heated above its adhesion temperature during the stretching procedure. The materials mostly substantially pure PP films and substantially pure PE films.

AT 393 648 B shows by way of example a film-stretching system with a roller arrangement which is substantially composed of two steel rollers defining the stretching gap and two associated rubber-covered rollers. To provide a simple method of changing the size of the stretching gap, it is possible to transpose the positions of the steel rollers and that of the rubber-covered rollers with respect to one another. Each rubber-covered roller is therefore associated with a steel roller in order that the film to be stretched is reliably applied under pressure to the steel stretching roller, and in order to inhibit inclusion of air between the steel stretching roller and the film to be stretched. It is essential here that the two stretching rollers which define a large or small stretching gap, depending on the arrangement, are made of steel, in order to maximize the smoothness of the surface of the film to be stretched. It is moreover of no importance that the coefficient of friction between the steel rollers and the synthetic film is low when the synthetic film is in its solid state, since the film to be stretched is heated to its adhesion temperature (about 120° C.) during the stretching process, reliably generating the static friction needed for the stretching process, even in cases where steel stretching rollers have high-gloss polished surfaces.

On the other hand, there are also known apparatuses of fundamentally different type for inducing strain in synthetic films, for example those according to WO 00/29199 A1, which have rollers with a toothed surface formed from ribs on their circumference and also having a corrugated structure in a circumferential direction. Synthetic films introduced between the rollers are therefore stretched transversely to the direction of passage through the gap between the two rollers, but what takes place here is not stretching under tension in a stretching gap defined between two stretching rollers. Rather, the films passed through the gap between the two rollers undergo transverse extension under pressure.

U.S. Pat. No. 4,806,300 A likewise shows an apparatus for the stretching of specifically nonwoven webs (known as nonwovens), in which two rollers have ridges running on their circumferences, and each ridge intermeshes with a depression on an adjacent roller, and the web passed through the gap between the two rollers is therefore subjected to extension in the transverse direction under pressure.

DE 2 360 556 A also shows an apparatus for inducing strain in thermoplastic polymer films, in which the film is passed through a gap arranged between two rollers, and its cross section is thus reduced under the pressure of the rollers, by applying pressure from the opposing roller surfaces, and the film is thus subjected to extension or strain.

It is now an object of the present invention to provide an apparatus and, respectively, a process of the nature stated at the outset, which can produce a porous, breathable synthetic film in a simple and efficient manner.

The apparatus according to the invention and of the nature stated at the outset is characterized in that, in order to produce a breathable synthetic film by means of tensile strain, the stretching rollers for the cold-stretching of the synthetic film have surfaces which increase the coefficient of friction. With the aid of the stretching rollers, which have surfaces whose coefficient of friction has been increased over that of steel stretching rollers conventionally used, synthetic films can be monoaxially cold-stretched (i.e. below the adhesion temperature of the synthetic film) under tension in a simple manner by virtue of the higher level of friction, so that after the stretching or drawing process they are porous and therefore breathable. The surfaces which increase the coefficient of friction here are present in particular in order to apply the friction needed between roller and synthetic film, so that the stretching procedure can take place exclusively under tension (i.e. by means of tensile strain) at comparatively low temperatures, the tensile force being exerted by virtue of different circumferential speeds of the two stretching rollers. Accordingly, the result of a stretching process of this type under tension is not, as hitherto, an improvement in the film with respect to its strength and its surface gloss, but that the film gains a new property, namely breathability. Unlike the hot-stretching process conventional hitherto, above the adhesion temperature, in which the tack of the film ensured adequate friction between stretching rollers and film even if the steel stretching rollers were smooth, the purpose of producing a breathable film which is stretched below its adhesion temperature is achieved by creating the required static friction between film and stretching rollers by means of the surfaces of the stretching rollers, these surfaces having been equipped with properties which increase the coefficient of friction.

In order to ensure reliably that the friction on the surface of the stretching rollers is adequate for cold-stretching, it is advantageous for the coefficient of friction of the surfaces of the stretching rollers to be from 0.2 to 2. It is also advantageous here for the Shore A hardness of the surface material of the stretching rollers to be from 15 to 95 and, respectively, their Shore D hardness to be from 15 to 80.

For simple design and efficient construction of the surfaces which increase the coefficient of friction on the stretching rollers, it is advantageous for the stretching rollers to have an outer layer which increases the coefficient of friction over that of the material of the stretching rollers. The possible methods of applying this outer layer to a steel cylinder are adhesive bonding, shrinking, or securing by form-fit, by means of protrusions interlocking into depressions.

In particular, with regard to reliably adequate friction of the synthetic film at the surfaces of the stretching rollers it is advantageous for the stretching rollers to be steel rollers with a rubberized outer layer, preferably made from a natural or synthetic elastomer. This firstly permits the stretching rollers to be heated internally in a simple manner to a temperature which is below the adhesion temperature of the synthetic film to be stretched, and secondly means that a high level of friction between the synthetic film and the surfaces of the stretching rollers is ensured with the aid of the rubberized outer layer, providing a simple way of producing a breathable, porous synthetic film.

If, viewed in the direction of conveying of the synthetic film, preheat rollers have been arranged upstream of the stretching rollers and stabilizer rollers have been arranged downstream of the stretching rollers, pressure rollers being associated with the preheat, stretching, and stabilizer rollers, the synthetic film is heated continuously to its stretching temperature prior to this stretching process, and the structure of the synthetic film is stabilized after the stretching procedure. With the aid of pressure rollers it is advantageously possible to ensure that the entire surface of the synthetic film is applied to the preheat, stretching, and stabilizer rollers, permitting avoidance of air inclusions between synthetic film and the preheat, stretching, or stabilizer rollers, and the resultant defects in the material.

Unlike films which are hot-stretched, for which it is mostly advantageous for the stretching gap to be relatively large in order to increase strength, during cold-stretching with the aid of the apparatus of the invention to produce the breathable structure of the stretched plastic film it is advantageous for the stretching gap to be small and for the distance between the roller surfaces of the stretching rollers to be not more than 10 mm. On the other hand, however, for the stretching process it is advantageous for the stretching gap to be at least 1 mm.

For stretching of the synthetic film under mild conditions and for achievement of a particularly fine-pored, breathable structure of the synthetic film after the stretching process, it is advantageous for the roller arrangement to have two pairs of stretching rollers, each with one stretching gap. It is advantageous here for there to be at least one stabilizer roller between the two pairs of stretching rollers, in order to stabilize the structure of the synthetic film between the two stretching procedures.

The process of the invention, of the nature stated at the outset, is characterized in that the synthetic film is cold-stretched below its adhesion temperature with the aid of stretching rollers provided with surfaces which increase the coefficient of friction. In contrast to the previously known hot-stretching of synthetic films under tension, where the friction between film and steel stretching rollers, which have to have a high-gloss polished surface since the roughness of the stretching rollers would otherwise be visible on the high-gloss films produced by hot-stretching, the intention in the process of the invention is to stretch or draw at below the adhesion temperature of the synthetic film, under tension, whereupon the surface friction used on the stretching rollers is increased, this friction being acceptable for breathable synthetic films, since irrespective of this factor breathable films have a comparatively rough surface.

If the temperature of the synthetic film during the stretching process is below 70° C., preferably below 60° C., operations during the stretching process for the synthetic film take place reliably below the adhesion temperature, and therefore the films after the stretching process has a porous structure.

Tests have shown that the synthetic films have a pronounced breathable structure after the cold-stretching process if the synthetic film is stretched with a stretching ratio of from 1:2 to 1:7.

To produce breathable synthetic films it is advantageous to stretch a PE synthetic film or PP synthetic film, or the like, or a PE/PP synthetic composite film, or the like. In order to ensure reliably that the synthetic film has a porous structure after the cold-stretching process, it is advantageous to stretch a synthetic film with non-stretchable fillers, preferably CaCO₃.

The invention is further illustrated below by taking as an example a preferred embodiment shown in the drawing, but there is no intention that it be restricted to this example. The details shown in the drawing are:

FIG. 1 a diagram of a view of the apparatus of the invention for the cold-stretching of synthetic films;

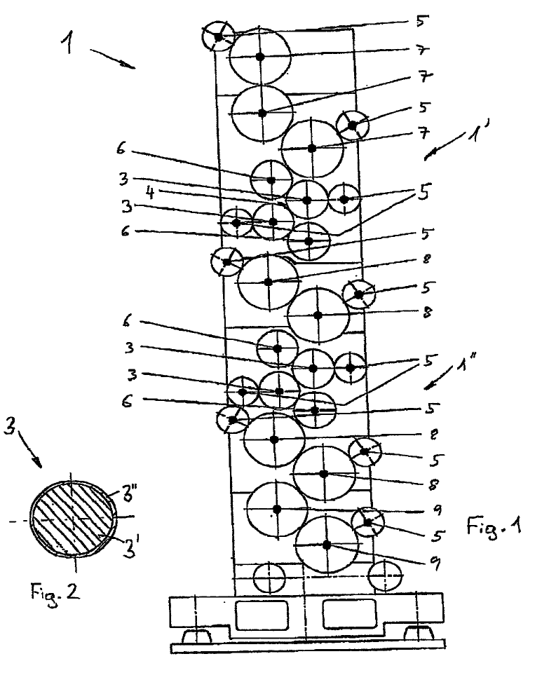

FIG. 2 a diagram of a cross section of a stretching roll of the invention;

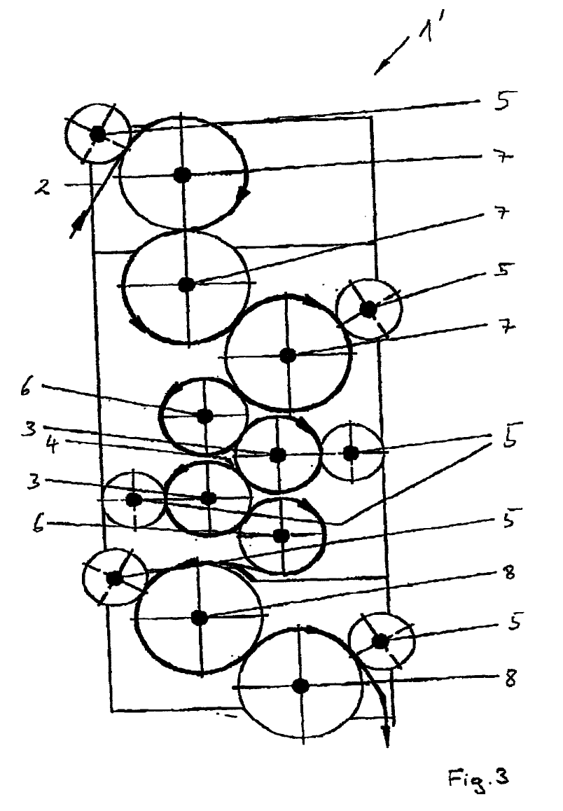

FIG. 3 a diagram of a view of a first stretching section of the apparatus of the invention according to FIG. 1.

FIG. 1 shows an apparatus 1 for the cold-stretching of breathable synthetic films, two-stage stretching being carried out here. The structure of the first stretching section 1′ only is described below, this section being shown in detail in FIG. 3; since the second stretching section 1″ has substantially the same structure, no detailed description of that is required.

A synthetic film 2 (see FIG. 3) is cold-stretched between two stretching rollers 3 which define a stretching gap 4, i.e. during the entire stretching procedure the synthetic film 2 is not heated above its adhesion temperature, and the synthetic film 2 is stretched under tension by the different circumferential speeds of the two stretching rollers 3. In order to ensure reliably that there is static friction between the stretching rollers 3 and the synthetic film 2 passed through between the two stretching rollers 3, the stretching rollers 3 have an outer surface 3″ which increases friction and is preferably composed of a synthetic or natural elastomer. The stretching roller core 3′ is a steel roller which is internally heated to achieve the stretching temperature of from about 60° to 70°.

A pressure roller 5 is associated with each of the stretching rollers 3 in order to ensure more reliably that the entire surfaces of the synthetic film 2 and the stretching rollers 3 are in contact without air inclusions.

To guide the synthetic film 2, upstream or downstream of the stretching rollers 3 there are what are known as prestretch rollers 6, which likewise have a rubberized surface for high coefficient of friction.

At the start of the stretching procedure, the synthetic film 2 is brought slowly to the temperature required for the stretching process, which, however, is below the adhesion temperature of the synthetic film 2, with the aid of preheat rollers 7, pressure rollers 5 being associated with at least some of these.

After the stretching process in the stretching gap 4, the synthetic film 2 is passed by way of what is known as the prestretch roller 6 to two stabilizer rollers 8 to stabilize the polymer structure of the synthetic film 2.

After the first stretching procedure in the stretching section 1′ shown in more detail in FIG. 3, another stretching process takes place in the second stretching section 1″, and (as can be seen from FIG. 1) there are also two chill rollers 9, each with associated pressure rollers 5, downstream of the stabilizer rollers 8 in the second stretching section 1″.

Polymer films, such as PE synthetic films, PP synthetic films, or PE/PP synthetic composite films, are particularly suitable for the production of breathable synthetic films if they comprise a non-stretchable filler, such as CaCO₃.

A porous breathable structure of the synthetic film 2 is reliably obtained with the aid of the embedded filler, which does not participate in the cold-stretching of the synthetic film in the stretching gap between the two stretching rollers 3 having a rubberized surface.

Instead of the rubberized outer layer 3″ of the stretching rollers 3, these may, of course, also have a roughened surface or the like in order to increase friction.

1. Apparatus (1) for monoaxial stretching of a synthetic film (2) under tension using a roller arrangement in which there are at least two stretching rollers (3) defining a stretching gap (4), characterized in that, in order to produce a breathable synthetic film (2) by means of tensile strain, the stretching rollers (3) for the cold-stretching of the synthetic film (2) have surfaces which increase the coefficient of friction.

2. Apparatus according to claim 1, characterized in that the surfaces of the stretching rollers (3) have a coefficient of friction of from 0.2 to 2.

3. Apparatus according to claim 1 or 2, characterized in that the surface material of the stretching rollers (3) has a Shore hardness A of from 15 to 95 and, respectively, a Shore hardness D of from 15 to 80.

4. Apparatus according to any of claims 1 to 3, characterized in that the stretching rollers (3) have an outer layer (3″) which increases the coefficient of friction over that of the core (3′) of the stretching rollers.

5. Apparatus according to claim 4, characterized in that the stretching rollers (3) comprise steel rollers with a rubberized outer layer (3″), preferably made from a natural or synthetic elastomer.

6. Apparatus according to any of claims 1 to 5, characterized in that, viewed in the direction of conveying of the synthetic film (2), there are preheat rollers (7) upstream of the stretching rollers (3) and stabilizer rollers (8) downstream of the stretching rollers (3), pressure rollers (5) being associated with the preheat, stretching, and stabilizer rollers (7, 3, 8).

7. Apparatus according to any of claims 1 to 6, characterized in that the stretching gap (4) is not more than 10 mm.

8. Apparatus according to any of claims 1 to 7, characterized in that the stretching gap (4) is at least 1 mm.

9. Apparatus according to any of claims 1 to 8, characterized in that the roller arrangement has two stretching-roller pairs (3, 3), each with one stretching gap (4).

10. Apparatus according to claim 9, characterized in that between the two stretching-roller pairs (3, 3) there is at least one stabilizer roller (8).

11. Process for the monoaxial stretching of a synthetic film (2) under tension, in which the synthetic film (2) is passed through at least one stretching gap (4) defined by two stretching rollers (3), characterized in that, in order to produce a breathable synthetic film (2), the synthetic film (2) is cold-stretched below its adhesion temperature with the aid of stretching rollers (3) having surfaces which increase the coefficient of friction.

12. Process according to claim 11, characterized in that during the stretching process the temperature of the synthetic film (2) is below 70° C., preferably below 60° C.

13. Process according to claim 11 or 12, characterized in that the synthetic film (2) is stretched using a stretching ratio of from 1:2 to 1:7.

14. Process according to any of claims 11 to 13, characterized in that the material stretched is a PE or PP synthetic film (2) or the like, or a PE/PP synthetic composite film or the like.

15. Process according to claim 14, characterized in that the material stretched is a synthetic film (2) with non-stretchable fillers, preferably CaCO₃.
